(19) United States
(12) Patent Application Publication
(10) Pub. No.: US 2003/0020980 A1
(43) Pub. Date: Jan. 30, 2003

(54) Methods for equalization of a DWDM system

(76) Inventors: Paul William Marsh, Nepean (CA); Gerard Gobeil, Gloucester (CA); Jeffrey K. Emery, Nepean (CA)

Correspondence Address: SMART & BIGGAR, P.O. BOX 2999, STATION D, 55 METCALFE STREET, SUITE 900, OTTAWA, ON, K1P5Y6, CA

(21) Appl. No.: 10/017,413

(22) Filed: Dec. 18, 2001

Related U.S. Application Data
(60) Provisional application No. 60/258,356, filed on Dec. 28, 2000.

(51) Int. Cl. H04B 10/08; H04J 14/02

(52) U.S. Cl. 359/110; 359/124

(57) ABSTRACT

This invention provides methods for equalization of a DWDM (dense wavelength division multiplex) fiber optic communication. Predetermined values of transmitter power adjustments are read from a database on an amplifier network element. New values of transmitter powers are calculated and applied to the transmitters in transmitter network elements. Also, methods for displaying the status of the transmitters and setting transmitter output power to maximum are provided.

### CROSS-REFERENCES TO RELATED APPLICATIONS

This application claims the benefit of U.S. Provisional Application No. 60/258,356, filed Dec. 28, 2000.

### FIELD OF THE INVENTION

This invention relates to dense wavelength division multiplexed (DWDM) optical systems, and more particularly to methods for equalization of DWDM optical systems.

### BACKGROUND OF THE INVENTION

In DWDM systems where EDFA (erbium doped fiber amplifiers) are used to amplify and regenerate optical signals not every wavelength is amplified equally. Also, signals of different wavelengths whose input power to an EDFA is not equal will be amplified at different levels. Due to this and other characteristics regarding the transmission of multiple wavelengths, the power of every wavelength input to an optical chain needs to be individually adjusted so that a figure of merit such as OSNR (optical signal to noise ratio) or BER (bit error rate) of the different wavelengths are relatively equal and at the optimum level for the receivers.

Methods for calculating the desired input power of optical receivers based on fiber characteristics, current input power levels and other parameters are well known in the industry. However, an operator must manually adjust the transmitter power levels according to the recommended power adjustments and wait for a recalculation. This procedure is repeated until the figure of merit values for each wavelength are substantially equal.

Manual intervention not only increases the provisioning time but also is highly error prone.

Thus, there is a need in the industry for a method that reduces the time to equalize a DWDM optical system and reduces human error.

### SUMMARY OF THE INVENTION

The present invention provides methods for equalization of DWDM systems, herein after called PBE (push button equalization).

According too an aspect of the present invention there is provided a method for setting output power levels of transmitters based on predetermined values stored in a database.

According to another aspect of the present invention there is provided a method for reading the values of current power levels, previous power levels and power level adjustments of the transmitters from the database and displaying the values of current power levels, previous power levels and power level adjustments of the transmitters on a user interface

According to another aspect of the present invention there is provided a method for setting output power levels of transmitters at their maximum power levels.

The invention may also be summarized according other aspects as a computer-readable media embodying a program of instructions executable by a computer to perform the above methods and at least one computer programmed to execute the above methods.

Advantageously, the invention decreases provisioning time and reduces error.

Other aspects and features of the present invention will become apparent to those ordinarily skilled in the art upon review of the following description of the specific embodiments of the invention in conjunction with the accompanying figures.

### BRIEF DESCRIPTION OF THE DRAWINGS

FIG. 1 is a block diagram of a conventional fiber optic communication system;

FIG. 2 is a block diagram of the software components of the present invention in relation to the fiber optic communication system of FIG. 1;

FIG. 3 is a flow chart showing the execution of a first method of an embodiment of the present invention;

FIG. 4 is a flow chart showing the execution of a second method of an embodiment of the present invention;

FIG. 5 is a flow chart showing the execution of a third method of an embodiment of the present invention; and

FIG. 6 is a flow chart showing the execution of a fourth method of an embodiment of the present invention;

### DETAILED DESCRIPTION OF THE PREFERRED EMBODIMENTS

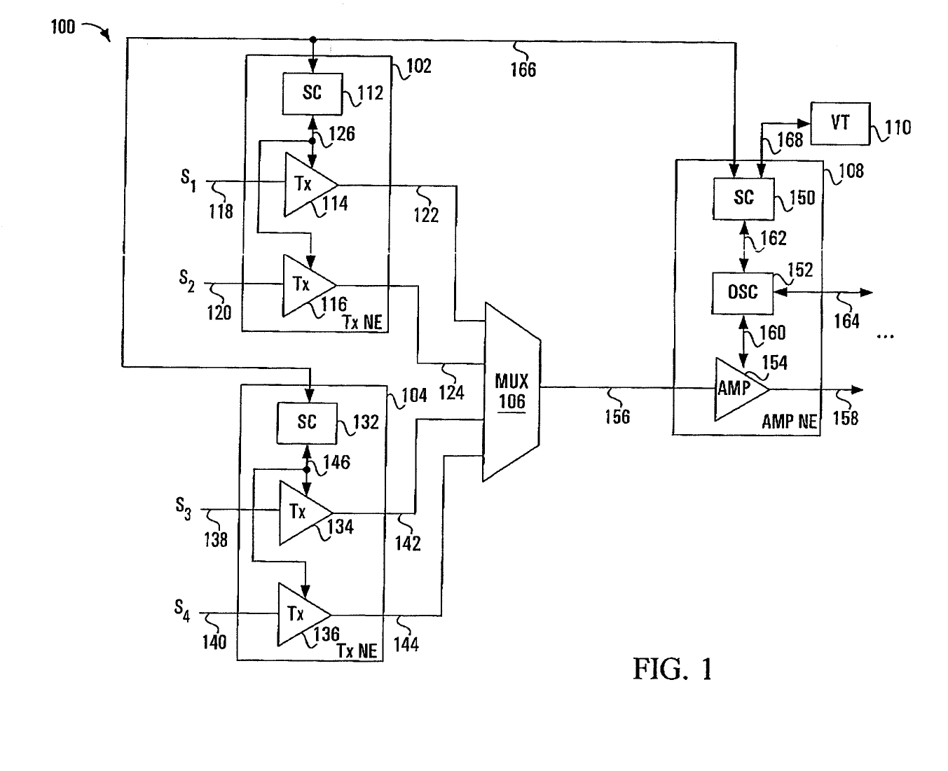

Referring to FIG. 1 there is shown a block diagram of a conventional fiber optic communication system 100 in accordance with an embodiment of the present invention. The fiber optic communication system 100 comprises a plurality of Tx NEs (transmitter network elements) (only two shown) shown as a first Tx NE 102 and a second Tx NE 104; a multiplexor 106 having a plurality of inputs (only four shown) and an output; a plurality of Amp NEs (amplifier network elements) (only one shown) shown as Amp NE 108; and a VT 110 (video terminal).

The first Tx NE 102 comprises an SC (shelf controller) 112 and a plurality of Txs (transmitters) (only two shown) shown as a first Tx 114 and a second Tx 116. An input of the first Tx 114 is connected 118 to an optical signal S₁. An input of the second Tx 116 is connected 120 to an optical signal S₂. An output of the first Tx 114 is connected 122 to a first input of the multiplexor 106. An output of the second Tx 116 is connected 124 to a second input of the multiplexor 106. The SC 112 is linked 126 to the first TX 114 and the second Tx 116.

The second Tx NE 104 is shown as identical in structure to the first Tx NE 102 for convenience. However, in reality, each Tx NE may have a different number of transmitters. An input of a first Tx 134 is connected 138 to an optical signal S₃. in input of a second Tx 136 is connected 140 to an optical signal S₄. An output of the first Tx 134 is connected 142 to a third input of the multiplexor 106. An output of the second Tx 136 is connected 144 to a fourth input of the multiplexor 106.

The Amp NE 108 comprises an SC 150, an OSC (optical service channel) 152 and an Amp (amplifier) 154. The Amp 154 is shown as a single-stage amplifier for convenience but in reality the Amp 154 may have multiple cascaded amplifier stages. The Amp 154 has an input connected 156 to the output of the multiplexor 106 and an output connected 158 to an input of an Amp in a succeeding Amp NE (not shown). The OSC 152 is linked 160 to the Amp 154, linked 162 to the SC 150 and is connected 164 to an OSC in the succeeding Amp NE (not shown). The connection 164 between the OSC 152 and the OSC in the succeeding Amp NE is shown as a separate connection for clarity, in reality it; may be integrated into the connection 158 between the output; of the Amp 154 and the input of the Amp in the succeeding Amp NE. Also, the OSC 152 is shown as a single channel for convenience but in reality the OSC 152 may comprise a plurality of optical service channels. The SC 150 is connected 166 to the SC 112 in the first Tx NE 102 and the SC 132 in the second Tx NE 104. This connection 166 may be, for example, an Ethernet connection. The SC 150 in the Amp NE 108 is also connected 168 to a video terminal 110. This connection 168 may be, for example, a serial RS-232 connection. The Amp NIL 108 may be, for example, located up to 20 km from the Tx NEs 102,104. The succeeding Amp NE (not shown) may be located, for example, up to 100 km from the Amp NE 108.

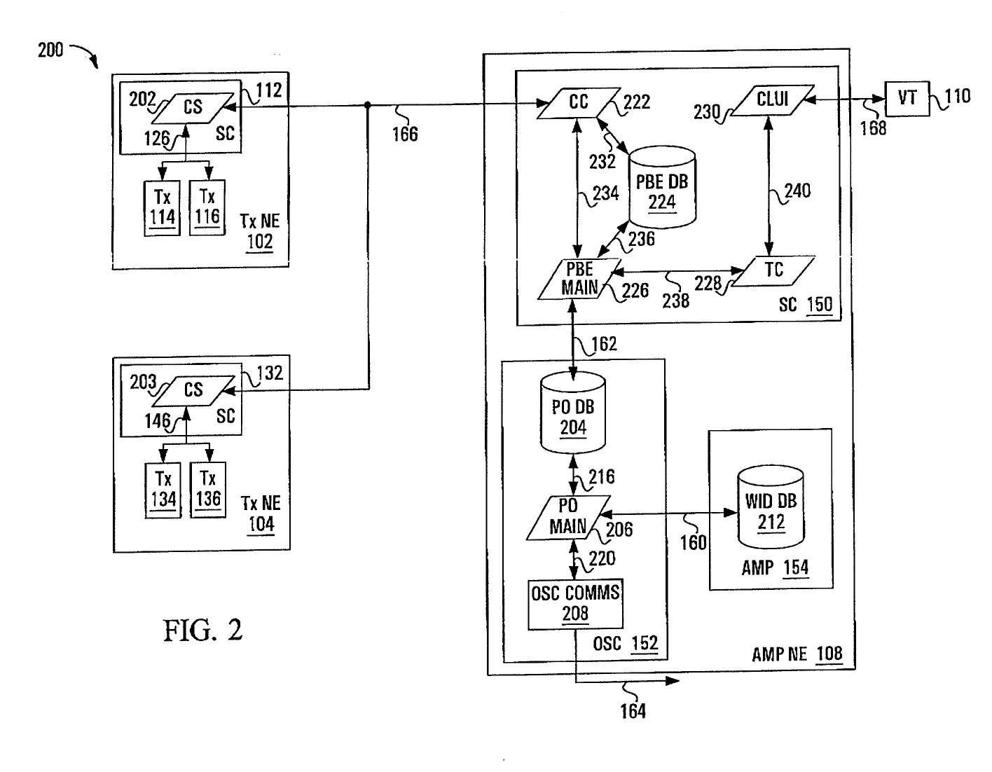

Referring to FIG. 2 there is shown a block diagram showing the relation of software components of the present invention to the fiber optic communication system 100 of FIG. 1. The software components of the present invention comprise a PBE main (push button equalization main) 226, a PBE DB (push button equalization database) 224, a CC (communications client) 222, a TC (traffic configure) 228 and a CLUI (command line user interface) 230 that reside in memory (not shown), such as flash or RAM (random access memory), on the SC 150 of the Amp NE 108. The PBE main 226, the CC 222, the TC 228 and the CLUI 230 are executed on a CPU (central processing unit) (not shown), such as a microprocessor or microcontroller, on the SC 150 of the Amp NE 108. PBE main 226 is linked 234 to the CC 222, linked 236 to the PBE DS 224 and linked 238 to the TC 228. The PBE DB 224 is also linked 232 to the CC 222. The CLUI 230 is linked 240 to the TC 228 and Linked 168 to the VT 110.

The software components of the present invention also comprise a CS (communications server) 202 residing in memory (not shown), such as flash or RAM, on the SC 112 of the first Tx NE 102. The CS 202 is executed on a CPU (not shown), such as a microprocessor or microcontroller, on the SC 112 of the first Tx NE 102. The CS 202 is linked 126 to the first Tx 114 and the second Tx 116. The PBE software components in the second Tx NE 104 are identical to the PBE software components in the first Tx NE 102. The CS 202 in first Tx NE 104 and the CS 203 in the second Tx NE 104 are linked 166 to the CC 222 in the Amp NE 108.

The software components of the present invention also comprise a PO (power optimizer) main 206, PO DS (power optimizer database) 204 and an OSC COMMS (optical service channel communications server) 208 residing in memory (not shown), such as flash or RAM, on the OSC 152. The PO main 206 and the OSC COMMS 208 are executed on a CPU (not shown), such as a microprocessor or microcontroller, in the OSC 152. The PO main 206 is linked 216 to the PO DS 204 and linked 220 to the OSC COMMS 208. The PO main 206 is also linked 160 to a WID DB (wave identification database) 212 residing in memory (not shown) in the Amp 154. The PO DB 204 is also linked 162 to the PBE main 226 in the SC 150. The OSC COMMS 208 is also linked 130 to an OSC COMMS in an OSC in the succeeding Amp NE (not shown).

The PO DB 204 contains information such as recommended power adjustments for each Tx 114,116,134,136. The PO DB 204 is continuously updated by the PO main 206. The methods for calculating the recommended power adjustments are described in U.S. patent application Ser. No. 09/667,680 entitled “WDM CHANNEL EQUALIZATION IN ADD/DROP-CAPABLE OPTICAL NETWORKS” by Sik H. Foo, filed on Sep. 22, 2000. The subject matter of this prior application is incorporated herein by reference.

Before a fiber optic communications system 100 can be equalized using PBE the locations of the Txs 114,116,134,136 must be stored in the PO DB 204. The Txs 114,116,134,136 send WaveID (wave identification) information unique to each transmitter. The Amp 154 and succeeding amplifiers (not shown) collect the WaveID information and store it in the WID DE 212. The PO main 206 store the WaveID information with the recommended power adjustments in the PO DB 204. WaveID is described in “METHOD AND APPARATUS FOR ANCILLARY DATA IN A WAVELENGTH DIVISION MULTIPLEXED SYSTEM” by James Harley et al, U.S. patent application Ser. No. 09/199,327, filed on Nov. 25, 1998 and assigned to Nortel Networks Corporation, which is incorporated herein by reference.

A first method of the present invention, herein after referred to as the EQ Start method, is a method for setting output power levels of the Txs 114,116,134,136 based on values of power level adjustments stored in the PO DB 204,

A second method of the present invention, herein after referred to as the EQ Status method, is a method for reading the values of current power levels, previous power levels and power level adjustments of the Txs 114,116,134,136 from the PBE DB 224 and displaying the values of current power levels, previous power levels and power level adjustments of the Txs 114,116,134,136 on the VT 110.

A third method of the present invention, herein after referred to as the EQ Continue method, is a method for setting output power levels of the Txs 114,116,134,136 based on values of power level adjustments stored in the PO DB 204 from within the EQ Status method when the EQ Status method is being executed for the first time.

A fourth method of the present invention, herein after referred to as the Init Tx to Max method, is a method for setting output power levels of the Txs 114,116,134,136 transmitters to their maximum power levels.

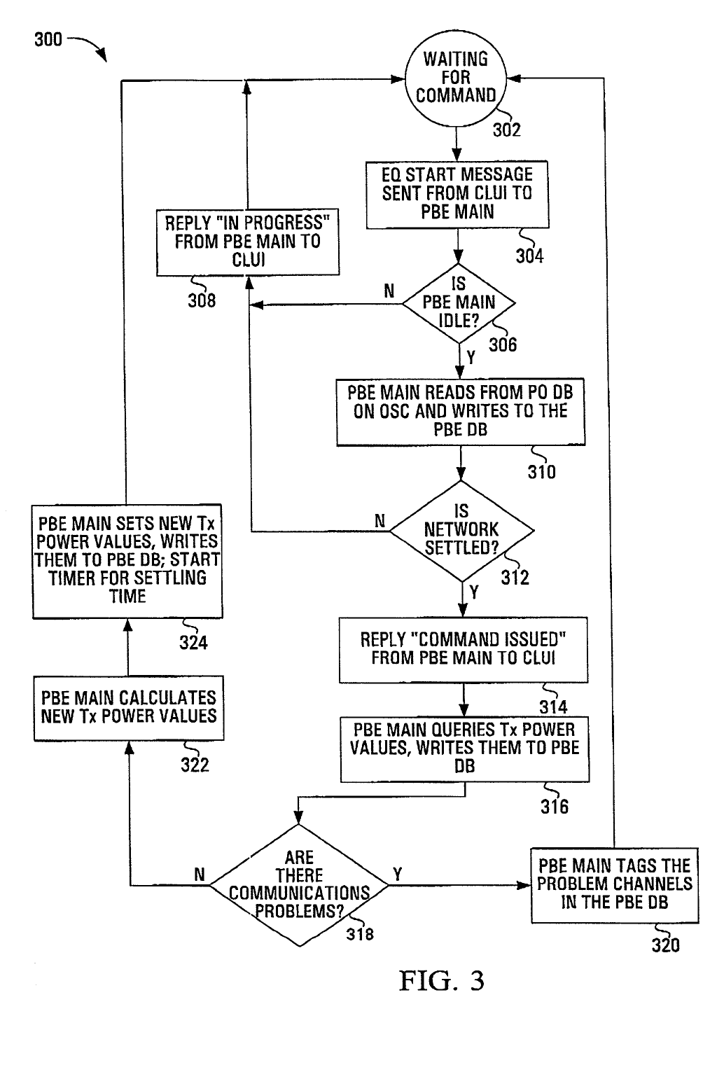

The EQ Start method is described with reference to flow chart 300 of FIG. 3. The PBE main 226 is idle until it receives an EQ Start message from the CLUI 230 via the TC 228 (Step 302). A user (not shown) initiates the execution of the EQ Start method by entering an EQ Start command on the VT 110 to the CLUI 230, which sends a message to the PBE main 226 via the TC 228 (Step 304). If the PBE main 226 is not idle (Step 306) then it responds to the CLUI 230 via the TC 228 indicating that a previous equalization iteration is “In Progress” (Step 308). Otherwise, the PBE main 226 reads the PO DB 204 on the OSC 152 (Step 310). This includes WaveID information specifying the locations of the Txs 114,116,134,136, recommended transmitter power adjustments and the time when the EQ Start method was previously executed. If the fiber optic communication system 100 has not settled (Step 312), i.e. the user has not waited long enough since the EQ Start or Init Tx to Max method was previously executed, then PBE main 226 responds to the CLUI 230 via the TC 228 indicating that the previous equalization iteration is “In Progress” (Step 308). Otherwise, the PBE main 226 replies to the CLUI 230 via TC 228 that the EQ Start command has been accepted and is being processed. The EQ Start command has been “issued” (Step 314). The PBE main 226 then queries the Txs 114,116,134,136 via the CC 222 for their settings, including Tx NEID (network element identification), minimum, maximum and current power level values. The CC 222 writes these to the ?BE DB 224 (Step 316). The PBE main 226 checks if there were any communications problems, i.e. the PBE main 226 could not communicate with any of the Txs 114,116,134,136. If there were some communication problems (Step 318), then these channels are tagged in the PBE DB 224 (Step 320) and the PEA main 226 returns to idle state (Step 302). Otherwise, the PBE main 226 calculates new transmitter power settings based on the current transmitter power settings and the recommended transmitter power adjustments from PO DB 204 (Step 322). The new power settings are the sum of the current power level values plus the power level adjustments limited to within the range of the minimum and maximum power levels. The PBE main 226 sets the new transmitter power settings via CC 222 and starts a timer (not shown) for the settling time (Step 324). The PBE main 226 then returns to idle and waits for the next message from the CLUI 230 (Step 302).

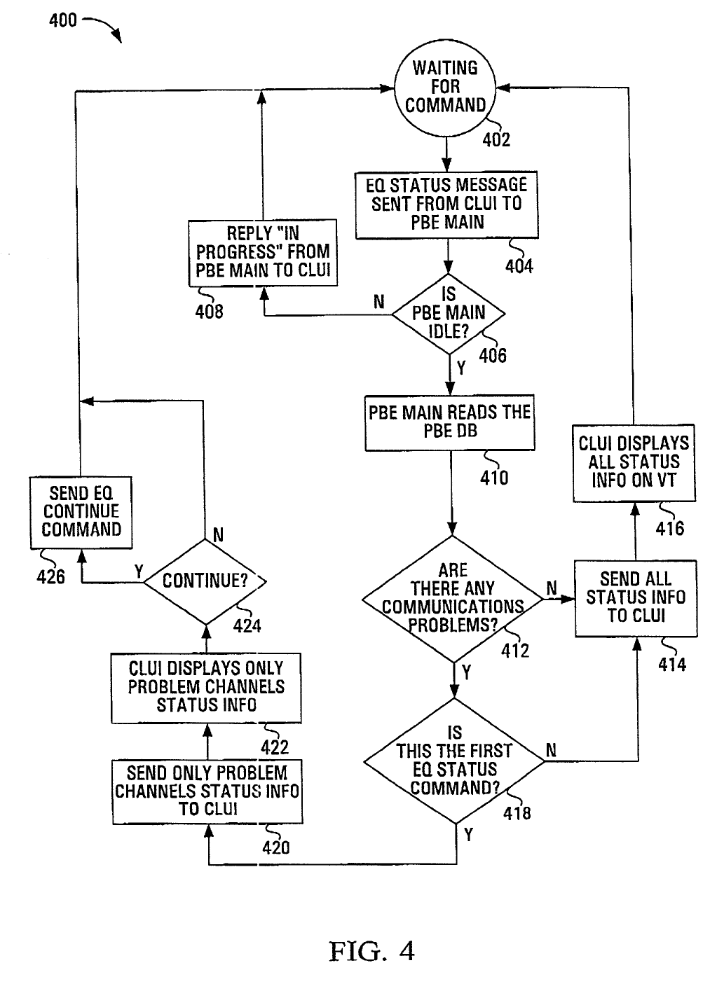

The EQ Status method is described with reference to flow chart 400 of FIG. 4. The PBE main 226 is idle until it receives an EQ Status message from the CLUI 230 via TC 228 (Step 402). The user initiates the execution of the EQ Status method by entering an EQ Status command on the VT 110 to the CLUI 230, that sends a message to the ?BE main 226 via TC 228 (Step 404). If the PBE main 226 is not idle (Step 406) it responds to the CLUI 230 via the TC 228 indicating that the previous equalization iteration is “In Progress” (Step 408). Otherwise, the PBE main 226 reads the channel status information from the PBE DB 204 (Step 410). This includes current and previous transmitter powers and power adjustment that were applied. The PBE main 226 also checks the PBE DB 204 to see if there were communication problems to some of the Txs 114,116,134,136 in a previous execution of the EQ Start method (these would be tagged) (Step 412). If there were no communication problems, then the status info is sent to the CLUI 230 (Step) 414) and the CLUI 230 displays the info on the VT 110 for the user (Step 416). If this was the first time the EQ Status method was executed since the EQ Status or Init Tx to Max methods were previously executed (Step 418), then a list containing only the transmitters which could not be communicated with is sent to the CLUI 230 (Step 420). The CLUI 230 displays this info on the VT 110 (Step 422) and prompts the user if he wishes to apply the power adjustments only to the transmitters which can be communicated with, or to do nothing (Step 424). If the user says “yes”, the software internally sends an EQ Continue message from the CLUI 230 to the PBE main 226 (Step 426). If this was not the first time the EQ Status method was executed since the EQ Status or Init Tx to Max methods were previously executed, then a list containing all of the transmitter info is sent to the CLUI 230 (Step 414). The CLUI 230 displays all of this information on the VT 110. The PBE main 226 then returns to idle and waits for the next message from the CLUI 230 (Step 402).

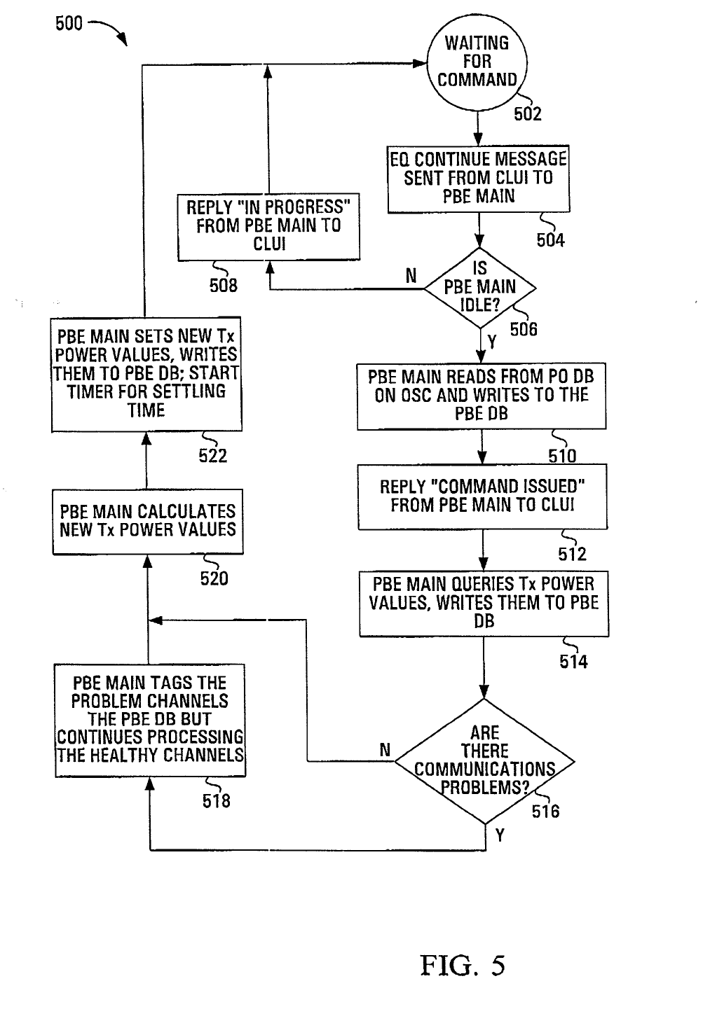

The EQ Continue method is described with reference to flow chart 500 of FIG. 5. The PBE main 226 is idle until it receives an EQ Continue message from the CLUI 230 via TC 228 (Step 502). The EQ Continue command is issued internally from the CLUI 230, as a result of the user entering “yes”from the EQ Status command prompt (Step 424). This sends the EQ Continue message to the PBE main 226 via TC 228 (Step 504). If the PBE main 226 is not idle (Step 506), it responds to the CLUI 230 via TC 228 indicating that the previous equalization iteration is “In Frogress” (Step 508). Otherwise, the PBE main 226 reads the PO DB 204 on the OSC 152. This includes the WaveID information specifying the locations of the Txs 114,116,134,136 and recommended transmitter power adjustments. The PBE main 226 then queries the Txs 114,116,134,136 via CC 222 for their settings, including their minimum, maximum and current power level values (Step 510). The PBE main 226 replies to the CLUI 230 that the EQ Continue command has been “issued” (Step 512). The PBE main 226 writes these to the PBE DB 204 (Step 514). The PBE main 226 checks if there were any communication problems (Step 516), i.e. the PBE main 226 could not communicate to some of the Txs 114,116,134,136. If there were some communication problems, then these are tagged in the PBE DB 204 (Step 518) but the PBE main 226 continues processing the healthy channels. The PBE main 226 then calculates the new transmitter power settings based on the current transmitter power settings and the recommended transmitter power adjustments from PO DB 204 (Step 520). The new power settings are the sum of the current power level values plus the power level adjustments limited to within the range of the minimum and maximum power levels. The PBE main 226 then sets the new power settings of Txs 114,116,134,136 via CC 222 and starts the timer for the settling time (Step 522). The PBE main 226 then returns to idle and waits for the next message from the CLUI 230 (Step 502).

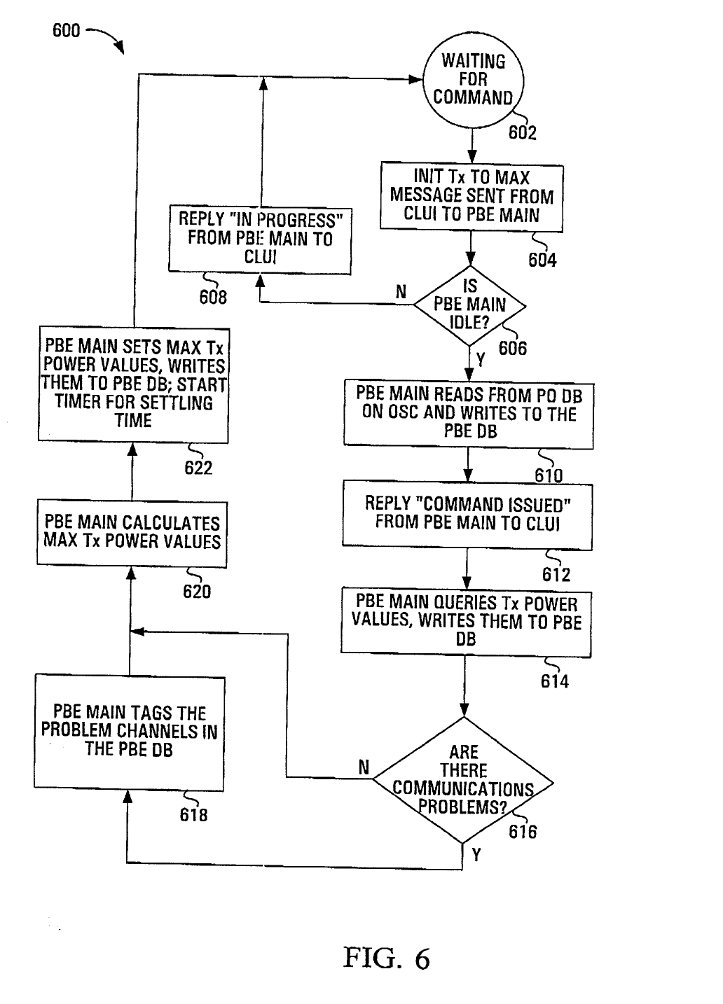

The Init Tx to Max method is described with reference to flow chart 600 of FIG. 6. The PBE main 226 is idle until it receives an Init Tx to Max message from the CLUI 230 via the TC 228 (Step 602). The user initiates the execution of the Init Tx to Max method by entering an Init Tx to Max command on the VT 110 to the CLUI 110, which sends an Init Tx to Max message to the PBE main 226 via TC 230 (Step 604). If the PBE main 226 is not idle (Step 606), it responds to the CLUI 230 via the TC 228 indicating that the previous equalization iteration is “In Progress” (Step 608). Otherwise, the PBE main 226 reads the PO DB 204 on the OSC 152 (Step 610). This includes the WaveID information specifying the locations of the Txs 114,116,134,136 and recommended transmitter power adjustments. The PBE main 226 replies to the CLUE 230 via the TC 228 that the Init Tx to Max command has been accepted and is being processed. The Init Tx to Max command has been “issued” (Step 612). The PBE main 226 then queries the Txs 114,116,134,136 via the CC 222 for their settings, including their minimum, maximum and current power level values. The PBE main 226 writes these to the PBE DB 204 (Step 614). The PBE main 226 checks if there were any communications problems (Step 616), i.e. the PBE main 226 could not communicate to some of the Txs 114,116,134,136. If there were some communications problems, then these are tagged in the PBE DB (Step 618) but the PBE main 226 continues to process the Txs 114,116,134,136 that it can communicate with. The PBE main 226 then calculates the transmitter power settings based on the maximum transmitter power level written in the PBE DB 204 (Step 620). The PBE main 226 then sets the transmitter power to maximum via the CC 222 and starts the timer for the settling time (Step 622). The PEE main 226 then returns to idle and waits for the next message from the CLUI 230.

Although the description of the invention has focused on a unidirectional fiber optic communications system, it should be understood that both unidirectional and bidirectional fiber optic communications systems are within the scope of the invention.

Those skilled in the art should also appreciate that in some embodiments of the invention, all or part of the functionality previously described herein with respect to the invention may be implemented as pre-programmed hardware or firmware elements such as application specific circuits, erasable programmable read-only memories or other similar components.

In other embodiments of the invention, all or part of the functionality previously described herein with respect to the invention may be implemented as software consisting of a series of instructions for execution by a computer system.

The series of instructions could be stored on a medium that is readable directly by the computer system (such as a removable diskette, CR-ROM, ROM or fixed disk) or the instructions could be stored remotely but transmittable to the computer system via a modem or other interface device connected to a network over a transmission medium.

Those skilled in the art should also appreciate that the series of instructions may be written in a number of programming languages for use with many computer architectures or operating systems. For example, some embodiments may be implemented in a procedural programming language such as “C” or an object oriented language such as “C++”.

While the preferred embodiment of the present invention has been described and illustrated, it will be apparent to persons skilled in the art that numerous modifications and variations are possible. The scope of the invention, therefore, is only to be limited by the claims appended hereto.

We claim:

1. In a fiber optic communication system having a plurality of network elements of a first type each having a plurality of transmitters, each of the transmitters having a minimum power level, a maximum power level and a current power level, a network element of a second type having a first database containing a respective plurality of values of power level adjustments and a second database, the network elements of the first type connected to the network element of the second type by optical fiber, the method comprising the steps of:
reading the plurality of values of power level adjustments from the first database;
querying the transmitters for their minimum power levels, maximum power levels and current power levels and writing the information to the second database;
calculating new values of transmitter power levels; and
setting the transmitter powers levels to the new power levels.

2. The method of claim 1 wherein the step of reading the plurality of values of power level adjustments from the first database further comprises writing the plurality of values of power level adjustments to the second database.

3. The method of claim 1 wherein the step of querying the transmitters further comprises checking for communications problems between the transmitters and the network element of the second type.

4. In a fiber optic communication system having a plurality of network elements of a first type each having a plurality of transmitters, a network element of a second type having a database containing a respective plurality of values of current power levels, previous power levels and power level adjustments of the transmitters, a user interface and the network elements of the first type connected to the network element of the second type by optical fiber, the method comprising the steps of:
reading the values of-current power levels, previous power levels and power level adjustments of the transmitters from the database; and
displaying the values of current power levels, previous power levels and power level adjustments of the transmitters on the user interface.

5. The method of claim 4 further comprising the step of checking for communication problems between the transmitters and the network element of the second type.

6. The method of claim 5 further comprising the steps of:
reading the plurality of values of power level adjustments from the first database;
querying the transmitters for their minimum power levels, maximum power levels and current power levels and writing the information to the second database;
calculating new values of transmitter power levels; and
setting the transmitter powers levels to the new power levels.

7. The method of claim 6 wherein the step of reading the plurality of values of power level adjustments from the first database further comprises writing the plurality of values of power level adjustments to the second database.

8. The method of claim 6 wherein the step of querying the transmitters further comprises checking for communications problems between the transmitters and the network element of the second type.

9. In a fiber optic communication system having a plurality of network elements of a first type each having a plurality of transmitters, each of the transmitters having a minimum power level, a maximum power level and a current power level, a network element of a second type having a first database containing a respective plurality of values of power level adjustments, a second database and the network elements of the first type connected to the network element of the second type by optical fiber the method comprising the steps of:
reading the plurality of values of power level adjustments from the first database;
querying the transmitters for values of their minimum power levels, maximum power levels and current power levels;
writing the values of the minimum power levels, maximum power levels and current power levels of the transmitters to the second database;
calculating new values of the maximum power levels of the transmitters; and
setting the transmitter powers levels to the new maximum power levels.

10. The method of claim 9 wherein the step of reading the plurality of values of power level adjustments from the first database further comprises writing the plurality of values of power level adjustments to the second database.

11. The method of claim 9 wherein the step of querying the transmitters further comprises checking for communications problems between the transmitters and the network element of the second type.

12. A fiber optic communication system comprising:
a plurality of network elements of a first type each having a plurality of transmitters, each of the transmitters having a minimum power level, a maximum power level and a current power level;
a network element of a second type having a first database containing a respective plurality of values of power level adjustments and a second database, the network elements of the first type being connected to the network element of the second type by optical fiber;
means for reading the plurality of values of power level adjustments from the first database;
means for querying the transmitters for the values of their minimum power levels, a maximum power levels and a current power levels and writing the values of their minimum power levels, a maximum power levels and a current power levels to the second database;
means for calculating new values of transmitter power levels; and
means for setting the transmitter powers levels to the new power levels.

13. The fiber optic communication system of claim 12 wherein means for reading the plurality of values of power level adjustments from the first database further comprises writing the plurality of values of power level adjustments to the second database.

14. The fiber optic communication system of claim 12 wherein the means for querying the transmitters further comprises means for checking for communications problems between the transmitters and the network element of the second type.

15. A fiber optic communication system comprising:
a plurality of network elements of a first type each having a plurality of transmitters;
a network element of a second type having a database containing a respective plurality of values of current power levels, previous power levels and power level adjustments of the transmitters, the network elements of the first type being connected to the network element of the second type by optical fiber;
a user interface;
means for reading the values of current power levels, previous power levels and power level adjustments of the transmitters from the database; and
means for displaying the values of current power levels, previous power levels and power level adjustments of the transmitters on the user interface.

16. The fiber optic communication system of claim 15 further comprising means for checking for communication problems between the transmitters and the network element of the second type.

17. The fiber optic communication system of claim 16 further comprising:
means for reading the plurality of values of power level adjustments from the first database;
means for querying the transmitters for their minimum power levels, maximum power levels and current power levels and writing the information to the second database;
means calculating new values of transmitter power levels; and
means for setting the transmitter powers levels to the new power levels.

18. A fiber optic communication system comprising:
a plurality of network elements of a first type each having a plurality of transmitters, each of the transmitters having a minimum power level, a maximum power level and a current power level;
a network element of a second type having a first database containing a respective plurality of values of power level adjustments and a second database, the network elements of the first type being connected to the network element of the second type by optical fiber;
means for reading the plurality of values of power level adjustments from the first database;
means for querying the transmitters for the values of their minimum power levels, maximum power levels and current power levels;
means for writing the minimum power levels, maximum power levels and current power levels of the transmitters to the second database;
means for calculating new values of maximum transmitter power levels; and
means for setting the transmitter powers levels to the new maximum power levels.

19. The fiber optic communication system of claim 18 wherein the means for reading the plurality of values of power level adjustments from the first database further comprises means for writing the plurality of values of power level adjustments to the second database.

20. The fiber optic communication system of claim 18 wherein means for querying the transmitters further comprises means for checking for communications problems between the transmitters and the network element of the second type.

21. Computer-readable media embodying a program of instructions executable by a computer to perform a method of equalization of a fiber optic communication system having a plurality of network elements of a first type each having a plurality of transmitters, each of the transmitters having a minimum power level, a maximum power level and a current power level, a network element of a second type having a first database containing a respective plurality of values of power level adjustments and a second database, the network elements of the first type connected to the network element of the second type by optical fiber, the method comprising the steps of:
reading the plurality of values of power level adjustments from the first database;
querying the transmitters for their minimum power levels, maximum power levels and current power levels and writing the information to the second database;
calculating new values of transmitter power levels; and
setting the transmitter powers levels to the new power levels.

22. Computer-readable media embodying a program of instructions executable by a computer to perform a method of equalization of a fiber optic communication system having a plurality of network elements of a first type each having a plurality of transmitters, a network element of a second type having a database containing a respective plurality of values of current power levels, previous power levels and power level adjustments of the transmitters, a user interface and the network elements of the first type connected to the network element of the second type by optical fiber, the method comprising the steps of:
reading the values of current power levels, previous power levels and power level adjustments of the transmitters from the database; and
displaying the values of current power levels, previous power levels and power level adjustments of the transmitters on the user interface.

23. Computer-readable media embodying a program of instructions executable by a computer to perform a method of equalization of a fiber optic communication system having a plurality of network elements of a first type each having a plurality of transmitters, each of the transmitters hating a minimum power level, a maximum power level and a current power level, a network element of a second type having a first database containing a respective plurality of values of power level adjustments, a second database and the network elements of the first type connected to the network element of the second type by optical fiber the method comprising the steps of:
reading the plurality of values of power level adjustments from the first database;
querying the transmitters for values of their minimum power levels, maximum power levels and current power levels;
writing the values of the minimum power levels, maximum power levels and current power levels of the transmitters to the second database;
calculating new values of the maximum power levels of the transmitters; and
setting the transmitter powers levels to the new maximum power levels.
